(19) United States
(12) Patent Application Publication
(10) Pub. No.: US 2025/0307573 A1
(43) Pub. Date: Oct. 2, 2025

(54) DISPLAY METHOD AND ELECTRONIC DEVICE

(71) Applicant: Lenovo (Beijing) Limited, Beijing (CN)

(72) Inventor: Peng ZHU, Beijing (CN)

(21) Appl. No.: 19/094,540

(22) Filed: Mar. 28, 2025

(30) Foreign Application Priority Data
Mar. 29, 2024 (CN) 202410382769.8

(51) Int. Cl. G06F 40/58; G06T 5/77

(52) U.S. Cl. CPC G06F 40/58; G06T 5/77

(57) ABSTRACT

The present disclosure discloses a display method. The display method includes: obtaining, in response to an activation of a target mode, a first display content currently displayed, where the first display content includes a first content related to a display layout and a second content related to language information displayed, and the second content includes content determined by non-text format information displayed; obtaining a target translation language content for the second content; and controlling a first display region of a device to display the first display content and a second display region to display a second display content, where the second display content includes the first content and the target translation language content for the second content.

### CROSS-REFERENCES TO RELATED APPLICATIONS

The present disclosure claims priority to Chinese Patent Application No. 202410382769.8, filed on Mar. 29, 2024, the content of which is incorporated herein by reference in its entirety.

### TECHNICAL FIELD

The present disclosure relates to the field of display technologies, and more specifically, relates to a display method and an electronic device.

### BACKGROUND

Currently, when an application or webpage with a non-native language interface is opened, there is typically a need for translation. Therefore, users often choose to use translation applications to translate the content displayed on the current page. However, during the relevant operations, users need to minimize the current application, locate the translation application, launch the translation application, and then reopen the previously minimized application to display the non-native language interface. At this point, users may use the translation application to select non-native text information in the non-native language interface to obtain corresponding translation content. This process is cumbersome. Additionally, when encountering certain non-native language applications or webpages that do not support text information selection, such as when the text information is embedded in an image, users may not directly select the text. In such cases, if users need to translate the unselectable content, they need to manually input the text information into the translation application to perform the translation, significantly impacting the user experience.

### SUMMARY

One aspect of the present disclosure provides a display method. The display method includes: obtaining, in response to an activation of a target mode, a first display content currently displayed, where the first display content includes a first content related to a display layout and a second content related to language information displayed, and the second content includes content determined by non-text format information displayed; obtaining a target translation language content for the second content; and controlling a first display region of a device to display the first display content and a second display region to display a second display content, where the second display content includes the first content and the target translation language content for the second content.

Another aspect of the present disclosure provides an electronic device, including a display screen and one or more processors. The display screen is configured to display content. The one or more processors are configured to: obtain, in response to an activation of a target mode, a first display content currently displayed, where the first display content includes a first content related to a display layout and a second content related to language information displayed, and the second content includes content determined by non-text format information displayed; obtain a target translation language content for the second content; and control a first display region of the display screen to display the first display content and a second display region to display a second display content, where the second display content includes the first content and the target translation language content for the second content.

Another aspect of the present disclosure provides a non-transitory computer-readable storage medium containing instructions that, when being executed, cause at least one processor to perform operations. The operations include: obtaining, in response to an activation of a target mode, a first display content currently displayed, where the first display content includes a first content related to a display layout and second content related to language information displayed, and the second content includes content determined by non-text format information displayed; obtaining a target translation language content for the second content; and controlling a first display region of the device to display the first display content and a second display region to display a second display content, where the second display content includes the first content and the target translation language content for the second content.

### BRIEF DESCRIPTION OF THE DRAWINGS

To provide a clearer explanation of the technical solutions in the embodiments of the present disclosure, a brief introduction to the drawings used in the embodiments is provided below. Apparently, the drawings described below are merely some embodiments of the present disclosure. For those of ordinary skill in the art, other drawings may also be obtained based on these drawings without exerting creative efforts.

FIG. 1 illustrates a flow chart of a display method according to some embodiments of the present disclosure.

FIG. 2 illustrates a display effect diagram of a display method according to some embodiments of the present disclosure.

FIG. 3 illustrates an application flow chart of a display method according to some embodiments of the present disclosure.

FIG. 4 illustrates a structural block diagram of a display device according to some embodiments of the present disclosure.

### DETAILED DESCRIPTION

Some specific embodiments of the present disclosure will now be described in detail with reference to the accompanying drawings, but these should not be construed as limiting the present disclosure.

It should be understood that various modifications may be made to the embodiments disclosed herein. Therefore, the following description should not be considered as limiting but rather as illustrative examples. Those skilled in the art will recognize other modifications that fall within the scope and spirit of the present disclosure.

The drawings included in the specification and constituting a part thereof illustrate some embodiments of the present disclosure and, together with the above general description of the present disclosure and the detailed description of the embodiments provided below, are used to explain the principles of the present disclosure.

The features and other aspects of the present disclosure will become apparent through the following description of preferred forms of embodiments, provided as non-limiting examples, with reference to the accompanying drawings.

It should also be understood that, although specific examples of the present disclosure are described, those of ordinary skill in the art may implement numerous equivalent forms of the present disclosure that possess the features described in the claims and, therefore, fall within the scope of protection defined thereby.

When combined with the drawings and in light of the detailed description below, the aforementioned and other aspects, features, and advantages of the present disclosure will become more apparent.

Some specific embodiments of the present disclosure will now be described with reference to the accompanying drawings. However, it should be understood that the disclosed embodiments are merely examples of the present disclosure and may be implemented in various ways. Familiar or repetitive functions and structures are not described in detail to avoid unnecessary or redundant details that may obscure the present disclosure. Therefore, the specific structural and functional details disclosed herein are not intended to be limiting but rather serve as a basis for the claims and as representative examples for instructing those of ordinary skill in the art to implement the present disclosure in substantially any suitable detailed structure.

The specification may use phrases such as “in one embodiment,” “in another embodiment,” “in yet another embodiment,” or “in other embodiments,” which may refer to the same or different embodiments of the present disclosure.

Some specific embodiments of the present disclosure will now be described in detail with reference to the accompanying drawings.

As shown in FIG. 1, some embodiments of the present disclosure provide a display method, including:

S1: In response to an activation of a target mode, obtaining a first display content currently displayed, where the first display content includes a first content related to a display layout and a second content related to language information displayed, and the second content includes content determined by non-text format information displayed.

S2: Obtaining a target translation language content for the second content.

S3: Controlling a first display region of a device to display the first display content and a second display region to display a second display content, where the second display content includes the first content and the target translation language content for the second content.

For example, the electronic device may have a plurality of modes, where the display effects presented by the electronic device differ depending on the mode, such as split-screen display mode, landscape display mode, portrait display mode, and so on. A translation mode may also be selected through a configuration menu, specifically including various forms of translation modes, such as mirror translation mode. When the user selects to activate a target mode or when the system automatically matches and activates a target mode after an application is launched, the activation of the target mode triggers the obtaining of the first display content currently displayed, such as information about an image or interface currently displayed on the screen. In some embodiments, the first display content includes the first content related to the display layout and the second content related to the language information displayed. The first content may include layout information for arranging elements such as image elements, icon elements, and text information, including the display positions of images or icons, overlay relationships, and the display direction of the overall view, such as horizontal or vertical display. The second content includes all content related to language information within the view, such as non-text format language information contained in images or icons, and text format information. By default, text format information is included, as translating text format information, such as information that may be copied, is fundamental. Therefore, emphasis is placed on non-text format information, which users are not able to copy and need to input manually. This information may be obtained automatically by the system without requiring user input. After obtaining the second content, the system may pass the second content to associated translation software to obtain the target translation language content for the second content based on the translation software. The types of languages involved in the second content are not fixed, and may include one or a plurality of languages, such as English and Japanese, or only English, not specifically determined. The resulting target translation language content may be in a single language, such as Chinese. Alternatively, the language content in different languages may also be translated into corresponding language content based on a user-preset matching relationship. After obtaining the first display content and the target translation language content, the second display content may be prepared and generated based on the first content in the first display content and the target translation language content. For example, a new view may be generated. At this point, the system may control the first display region of the device to display the first display content while the second display region displays the generated second display content. For instance, the first display content and the second display content may be displayed simultaneously on the same screen or on different screens of different displays. The first display region and the second display region are not necessarily limited to the same display screen but may also be located on different display screens of different monitors, depending on the implementation.

The method in some embodiments of the present disclosure may allow a user to translate currently displayed content without manually inputting the content to be translated. The system may automatically capture text format language information, non-text format language information, and display layout-related information of the currently displayed content. The system may then automatically control the device to translate the text format language information and the non-text format language information to obtain a corresponding target translation language content. Finally, based on the display layout-related information and the target translation language content, the system may generate the second display content. The system may then control the device to display the first display content and the second display content in different display regions of the device for the user to view. Since the language information in the second display content is translated into a language that the user may understand, and since the display and layout-related information of the second display content corresponds to that of the first display content, the second display content and the first display content at least have similarities. The user may directly and intuitively comprehend the specific display information of the first display content by viewing the second display content, which facilitates the efficient extraction of required information and improves the user experience with the device.

According to some embodiments of the present disclosure, the method further includes:
S4: In response to an activation of a first target mode, controlling the first display content to be displayed in a first display region and the second display content to be displayed in a second display region, where a display region of a display screen may be divided into at least the first display region and the second display region; or
S5: In response to an activation of a second target mode, controlling the first display content to be transmitted through a first channel and displayed in a first display region of a first device, and controlling the second display content to be transmitted through a second channel and displayed in a second display region of a second device, where the first channel and the second channel are different.

For example, when the device activates the first target mode, which may be a split-screen display mode, the system may control the display screen to divide the display region into at least two sub-regions, forming the first display region and the second display region. Additionally, the system may divide the display region into three, four, or a plurality of sub-display regions, and the specific configuration is not fixed. The division method may vary, such as horizontal or vertical division, and the specific method is not fixed. In this embodiment, as an example, the first display region and the second display region are displayed symmetrically on the left and right. Once the display region is divided, the system may control the first display content to be displayed in the first display region and the second display content to be displayed in the second display region.

Alternatively, when the device activates the second target mode, such as a screen-casting mode that requires the participation of another display device, the participating display device may be connected to the current device either via a wired or wireless connection. The participating display device may be an extension device of the current device, or an independent device wirelessly connected to the current device. In the current second target mode, when displaying the first display content and the second display content, the system may control the first display content to be transmitted through a first channel and displayed in a first display region of the display screen of the current device. The first display region may be a display window on the screen or the entire display region. Subsequently, the second display content may be transmitted through a second channel to a second device and displayed in a second display region of the second device, such as transmitting the second display content through a communication channel established between the two devices. The second device may display the second display content in a display window or across the entire display region of its screen, and the specific configuration is not unique.

Further, the response to the activation of the first target mode includes:
S6: Controlling to generate a second window and displaying the second window in the second display region, where the second window is configured to display the second display content. The first display content is a first application displayed in a first window, and the second display content is a second application displayed in the second window. The size of the first window is the same as the size of the first display region, and the size of the second window is the same as the size of the second display region.

Continuing with the example of the first target mode as the split-screen display mode, in response to the activation of the first target mode, the system may control to generate a second window and display the second window in the second display region to show the second display content. Simultaneously, the first window for displaying the first display content is displayed in the first display region. In this embodiment, the first display content is defined as the content of a first application displayed by the first window. For example, after launching the first application, the system may execute the application and generate a corresponding display interface, which is displayed through the first window. The second display content is defined as the content of a second application displayed by the second window. However, the second display content is strongly associated with the first display content. For example, the first application may be any application, such as a web browser, an e-book reader, or an image viewer. The second application may be a translation application. The second application may display the translated content of the first display content in the second window. This configuration enables the untranslated content and the translated content to be displayed simultaneously in different display regions of the screen, facilitating the user in viewing and extracting the required information. To enhance the user's viewing experience, the first display region and the first window may have the same size and shape, while the second display region and the second window may also have the same size and shape. With this configuration, the first display content and the second display content may achieve proportional display, further improving the user experience and making it easier for the user to view the translated content.

In some embodiments, controlling the first display region of the device to display the first display content and the second display region to display the second display content includes:
S7: Controlling the device to generate a first display region and a second display region, where the first display region and the second display region have the same shape and are symmetrically positioned; and
S8: Controlling the first display region to display the first display content and the second display region to display the second display content, where a first content element of the first display content is the same as a first content element of the second display content, the second content has a first relative position with respect to the first content element in the first display content, the target translation language content for the second content has a second relative position with respect to the first content element in the second display content, and the first relative position matches the second relative position.

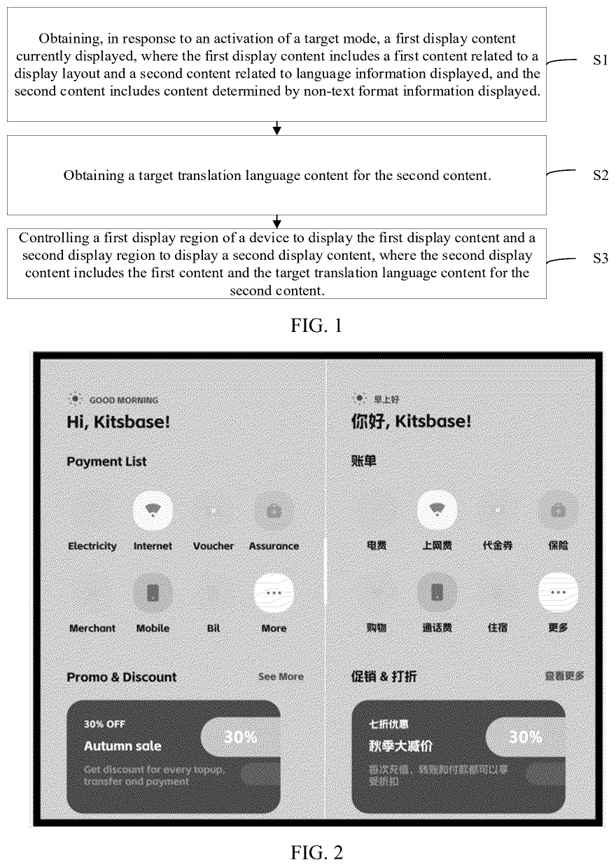

For example, when the system controls the device to display the first display content and the second display content, the system first divides the display region of the screen into a first display region and a second display region with the same shape and symmetrical positioning, such as left-right or top-bottom symmetry. The system then controls the first display region to display the first display content and the second display region to display the second display content. Since the first display content and the second display content include the same first content, the first display content and the second display content contain identical first content elements. The first content elements may be understood as elements such as images or icons in the first display content. The position of the elements in the view or webpage corresponding to the first display content matches their position in the view or webpage corresponding to the second display content, such as having proportional or identical position coordinates. Furthermore, the second content in the first display content has a first relative position with respect to the first content element, and the second content in the second display content has a second relative position with respect to the first content element. The first relative position matches the second relative position, for example, in terms of proportional or identical relative position coordinates. Since the differences in the second content between the first display content and the second display content involve language differences in all text and non-text format languages, the method of the present disclosure is based on the same first content element, the matching of the placement positions of the first content element in each display content, the second content being translation results of each other, and the matching of the placement positions of the second content in each display content. In other words, the position matching of the first content element relative to each display content may achieve a “mirror translation” effect of the first display content or an effect similar to “mirror translation,” such as differences in display size, i.e., only the display ratio is different, but the structure and content of the display results are identical. For example, as shown in FIG. 2, two different display regions of the device's display screen respectively display the overall content of the view before translation and the overall content of the view after translation. As shown in FIG. 2, the first display content on the left and the second display content on the right correspond almost one-to-one or may be described as “replicated.” For instance, the arrangement and names of the icons at the top of the left and right images (including the Chinese and English names of items such as Internet fee, vouchers, insurance, accommodation fee, and their corresponding icons), as well as the color, shape, and positions of the image element labeled “Autumn sale” and the element labeled “ [symbol] ,” are all consistent and corresponding. This truly achieves mirror translation, allowing users to see the display effect of the current view or webpage in different languages on the display screen. This enables zero-operation translation for the user while significantly improving the experience in viewing translation results.

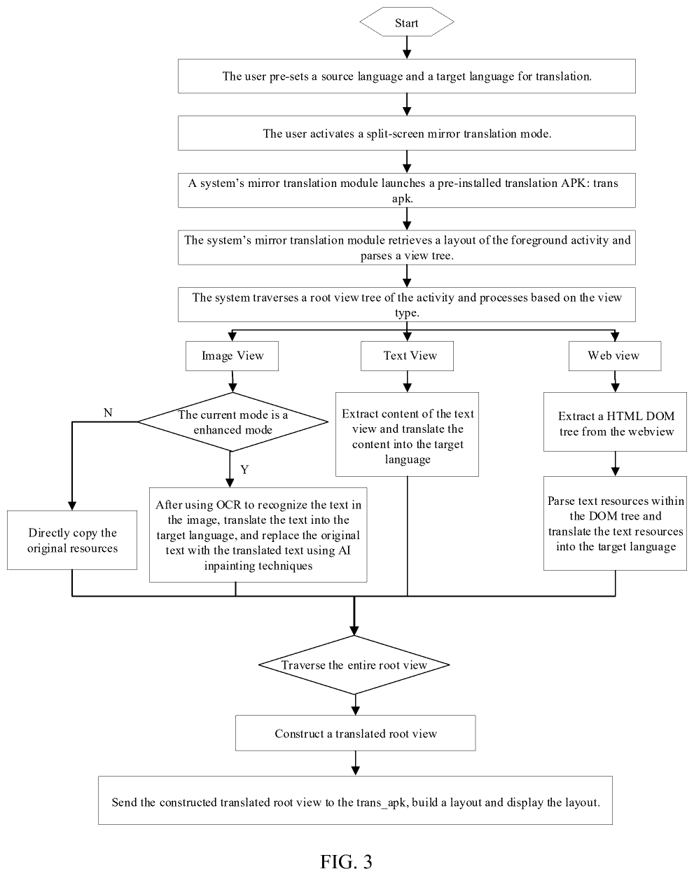

In some embodiments, as shown in FIG. 3, obtaining the first content, performed by the system, includes:
S9: Obtaining a display structure and a non-text format content element of the first display content as the first content, where the display structure includes layout information of the text format content element and the non-text format content element, and the non-text format content element forms the first content element.

For example, the first display content may be a view or webpage. The system may obtain display structure information of the first display content, such as layout information for a plurality of different types of display elements, the overall display architecture of the view, basic display architecture information of the webpage, and information on the individual display elements. The elements primarily include non-text format content elements, referred to as the first content element, which may include icons, background elements, etc., with specific details not fixed.

Further, obtaining the second content includes:
S10: At least determining a view region in the first display content that contains non-text format text information;
S11: Recognizing text information within the view region to obtain the second content; or
S12: Obtaining a view tree or an object model of the first display content to determine the second content based on text resources in the view tree or the object model.

Exemplarily, when obtaining the second content of the current first display content, the system may choose to identify content elements in the first display content that contain non-text format text information, such as images containing text information, picture-in-picture elements containing text information, or icons containing text information. Based on the content elements, the system may determine their corresponding view regions, which are the regions to be subjected to text recognition. For instance, when the current display is a settings interface containing option bars with different text and icons, where the option bars are in a non-text format and their text information may not be copied, the system may delineate each configuration bar containing text information as the view regions for text recognition. Alternatively, the currently displayed content may be a webpage that presents multiple images, where different images contain different types of content. Some images may include photographs, while other images contain textual information that is not able to be copied or extracted. In such cases, the system determines the area where the image containing textual information is located as the view region for text recognition. Once the view region is determined, the system recognizes the textual information within the view region to obtain the second content to be translated. However, if all textual information may be copied and extracted, the system directly copies the textual information for translation.

Alternatively, for the settings interface, the system may obtain the corresponding view tree information (e.g., viewtree/rootview), or for the webpage interface, the system may obtain the corresponding object model information (e.g., HTML DOM). Both the view tree and the object model include all formats of text information. That is, both the view tree and the object model include all content elements and the layout information for all content elements. Consequently, both the view tree and the object model contain the second content and the first content. The system may obtain the second content to be translated and the first content of the first display content based on the corresponding view tree or object model.

In practical applications, the system in this embodiment may obtain the corresponding view tree or object model based on the type of first display content, such as a standard view or webpage view. Obtaining the first content and the second content based on the view tree or object model is simple and efficient, enhancing the information capture efficiency. Furthermore, for the extraction of the second content, after determining the view region containing text information, the system may first determine whether the text information in the view region is in a format that allows for direct copying. If so, as described above, the text information may be directly copied for translation. If not, the system may determine that enhanced processing of the view region is required, such as entering an enhanced mode. In this case, the system may recognize the text information within the view region to obtain the second content.

In one embodiment, continuing with FIG. 3, the method may further include:
S13: Determining, based on the first content, a display structure and a non-text format content element of the second display content;
S14: Constructing a view tree corresponding to the second display content based on the display structure of the second display content, the non-text format content element, and the target translation language content; and
S15: Controlling to display the second display content based on the view tree corresponding to the second display content.

Exemplarily, after obtaining the first content and the target translation language content, the system may generate the second display content based on the first content and the target translation language content. This may include determining the overall display architecture of the second display content, the non-text format content element to be included, the text format content element, and the layout information of each content element, based on the first content, which includes all content elements involved in the first display content and their layout, as well as the overall display architecture information of the first display content. Subsequently, the view tree corresponding to the second display content may be constructed based on the determined display structure of the second display content, the non-text format content element, the text format content element, and the obtained target translation language content. Even when the first display content is a webpage, the format of the second display content may still be a regular view, so constructing the view tree alone may suffice. Once the view tree is constructed, the construction of the second display content is effectively completed. At this point, the system may control the device to display the second display content based on the view tree corresponding to the second display content.

For example, in actual applications, when the system launches the translation program and enters split-screen display mode, or when the system launches the mirror translation mode and enters the split-screen display state, a trans_apk instruction may be initiated. In response to the trans_apk instruction, the system may obtain the viewtree of the original apk, which corresponds to the viewtree of the currently displayed view. Based on this, the system may construct a viewtree corresponding to the second display content, which is the viewtree of the translated view.

When parsing the viewtree or object model of the original view or webpage to obtain the first content and the second content, obtaining the second content may involve using text recognition technology on image resources and icon resources to extract textual information from images for translation into target language textual information. For string resources, textual information may be directly extracted for translation into target language textual information. For a webpage view (webview), webkit may be used to parse the HTML DOM tree resources (i.e., object model) to obtain the corresponding first content and second content. Once the first content and the second content are obtained, the second content may be translated to generate a target translation language content. Finally, the target translation language content and the first content may be loaded into the trans_apk window, constructing the view tree corresponding to the second display content. Ultimately, the interface may be refreshed based on the newly constructed view tree, displaying the second display content.

Continuing with FIG. 3, the method may further include:
S16: Replacing the target translation language content for the text information included in the corresponding non-text format content elements into the text information area of the corresponding content element using an inpainting method to update the content element.

Constructing the view tree corresponding to the second display content based on the display structure of the second display content, the non-text format content element, and the target translation language content includes:
S17: Constructing the view tree corresponding to the second display content based on the display structure of the second display content, the updated non-text format content element, and the target translation language content.

For example, after translating the text information included in the content elements of images or icons into the target language, the corresponding target translation language content may replace the text information area in the original images or icons using an inpainting method or AI-generated images to update the content element. Subsequently, the view tree corresponding to the second display content may be constructed based on the display structure of the corresponding second display content, the updated non-text format content element, and the target translation language content, thereby enabling to display the second display content.

In some embodiments, the method may further include:
S19: Monitoring changes in the first display content within the first display region to synchronously update the second display content displayed in the second display region, where the size of the first display region changes along with the size of the second display region.

In other words, the system may continuously monitor changes in the first display content within the first display region. When the first display content changes, the system may repeat the above steps to synchronously update and generate the corresponding second display content and update the second display content in the second display region to achieve synchronized display and translation. To improve the display effect of the translated content and the original content, that is, to enhance the display effect of the first display content and the second display content, the system in some embodiments of the present disclosure may continuously monitor changes in the size of the second display region. When the size of the second display region changes, the system may synchronously adjust the size of the first display region to ensure that the sizes and shapes of the two display regions remain identical.

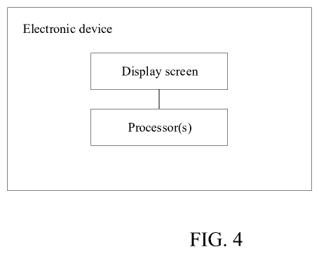

As shown in FIG. 4, according to some embodiments of the present disclosure, an electronic device is also provided. The electronic device includes:

A display screen, configured to display content;

A processor, configured to: obtain, in response to an activation of a target mode, a first display content currently displayed, where the first display content includes a first content related to a display layout and a second content related to displayed language information, and the second content includes content determined by the displayed non-text format information; obtain a target translation language content for the second content; and control a first display region of a display screen to display the first display content and a second display region to display second display content, where the second display content includes the first content and the target translation language content for the second content.

The electronic device may include, but is not limited to, a laptop, desktop, tablet, server, or other devices. The first display region and the second display region may be located on the same device or on different devices. That is, in some embodiments of the present disclosure, the processor of the electronic device may control the display of other electronic devices, thereby enabling functionalities such as screen mirroring.

In some embodiments, the processor may further be configured to:

In response to an activation of a first target mode, control the first display content to display in the first display region and the second display content to display in the second display region, where a display region of the screen may be divided into at least the first display region and the second display region; or

In response to an activation of a second target mode, control the first display content to be transmitted and displayed in a first display region of a first device through a first channel, and control the second display content to be transmitted and displayed in a second display region of a second device through a second channel, where the first channel and the second channel are different.

In some embodiments, the response to the activation of the first target mode may include:

Controlling to generate a second window and displaying the second window in the second display region. The second window is configured to display the second display content. The first content is displayed in a first window as a first application, and the second content is displayed in the second window as a second application. The size of the first window is the same as the size of the first display region, and the size of the second window is the same as the size of the second display region.

In some embodiments, controlling the first display region of the device to display the first display content and the second display region to display the second display content may include:

Controlling the device to generate a first display region and a second display region with identical shapes and symmetrical positions; and

Controlling the first display region to display the first display content and the second display region to display the second display content, where a first content element in the first display content and a first content element in the second display content are identical, the second content has a first relative position to the first content element in the first display content, and the target translation language content for the second content has a second relative position to the first content element in the second display content, where the first relative position matches the second relative position.

In some embodiments, obtaining the first content may include:

Obtaining a display structure and a non-text format content element of the first display content as the first content, where the display structure includes layout information for a text format content element and the non-text format content element, and the non-text format content element forms the first content element.

In some embodiments, obtaining the second content includes:
At least determining a view region of the first display content that contains non-text format text information;
Recognizing text information within the view region to obtain the second content; or
Obtaining a view tree or an object model of the first display content and determining the second content based on text resources in the view tree or the object model.

In some embodiments, the one or more processors are further configured to:
Determine a display structure and a non-text format content element of the second display content based on the first content;
Construct a view tree corresponding to the second display content based on the display structure and the non-text format content element of the second display content, and the target translation language content; and
Control to display the second display content based on the view tree corresponding to the second display content.

In some embodiments, the one or more processors are further configured for:
Replacing the text information in the non-text format content element with the target translation language content for the text information contained in the non-text format content element using an inpainting method to update a corresponding content element; and
Constructing the view tree corresponding to the second display content based on the display structure and the non-text format content element of the second display content, and the target translation language content, including:
Constructing the view tree corresponding to the second display content based on the display structure and an updated non-text format content element of the second display content, and the target translation language content.

In some embodiments, the one or more processors are further configured to:
Monitor changes in the first display content within the first display region to synchronously update the second display content displayed within the second display region, where the size of the first display region changes as the size of the second display region changes.

According to some embodiments of the present disclosure, a storage medium is also provided. The storage medium includes a stored program that, when executed, controls a device including the storage medium to perform the display method described in any of the embodiments above.

The present disclosure further provides a computer program product. The computer program product is tangibly stored on a computer-readable medium and includes computer-readable instructions. When executed, the computer-executable instructions cause at least one processor to perform the display method as described in the embodiments above. It should be understood that the various schemes in these embodiments have the corresponding technical effects described in the method embodiments above and are not repeated here.

It should be noted that the computer storage medium of the present disclosure may be a computer-readable signal medium, a computer-readable storage medium, or any combination thereof. A computer-readable medium may include, but is not limited to, systems, devices, or apparatuses based on electrical, magnetic, optical, electromagnetic, infrared, or semiconductor, or any combination thereof. For example, the computer-readable storage medium may include, but are not limited to, electrical connections with one or more wires, portable computer disks, hard disks, random access memory (RAM), read-only memory (ROM), erasable programmable read-only memory (EPROM or flash memory), optical fibers, portable compact disk read-only memory (CD-ROM), optical storage media, magnetic storage media, or any suitable combination thereof. In the present disclosure, a computer-readable storage medium refers to any tangible medium containing or storing a program that may be used by or in conjunction with an instruction execution system, device, or apparatus. A computer-readable signal medium may include a propagated data signal that carries computer-readable program code, either in a baseband or as part of a carrier wave. Such a propagated data signal may take various forms, including but not limited to, electromagnetic signals, optical signals, or any suitable combination thereof. A computer-readable signal medium may also be any computer-readable medium other than a computer-readable storage medium. Such a computer-readable medium may transmit, propagate, or transfer programs configured to be used by or in conjunction with an instruction execution system, device, or apparatus. The program code contained on a computer-readable medium may be transmitted using any suitable medium, including but not limited to, wireless, antenna, optical fiber, RF, and any suitable combination thereof.

Those skilled in the art should understand that the discussion of any of the embodiments above is exemplary only and is not intended to imply that the scope of the present disclosure is limited to these examples. Within the scope and spirit of the present disclosure, features of the embodiments described above or in different embodiments may also be combined, steps may be performed in any sequence, and many other variations of the one or more aspects of the embodiments described above may exist, which are not detailed here for simplicity.

The above embodiments are merely exemplary embodiments of the present disclosure and are not intended to limit the present disclosure. The scope of protection of the present disclosure is defined by the claims. Those skilled in the art may make various modifications or equivalent replacements to the present disclosure within its essence and scope, and such modifications or equivalent replacements should also be considered to fall within the scope of protection of the present disclosure.

What is claimed is:

1. A display method, comprising:
obtaining, in response to an activation of a target mode, a first display content currently displayed, wherein the first display content comprises a first content related to a display layout and a second content related to language information displayed, and the second content comprises content determined by non-text format information displayed;
obtaining a target translation language content for the second content; and
controlling a first display region of a device to display the first display content and a second display region to display a second display content, wherein the second display content comprises the first content and the target translation language content for the second content.

2. The display method of claim 1, further comprising:
in response to an activation of a first target mode, controlling the first display content to be displayed in the first display region and the second display content to be displayed in the second display region, wherein a display region of a screen is able to be divided into at least the first display region and the second display region; or
in response to an activation of a second target mode, controlling the first display content to be transmitted through a first channel and displayed in a first display region of a first device, and controlling the second display content to be transmitted through a second channel and displayed in a second display region of a second device, wherein the first channel and the second channel are different.

3. The display method of claim 2, wherein the response to the activation of the first target mode comprises controlling to generate a second window and displaying the second window in the second display region, wherein
the second window is configured to display the second display content;
the first display content is a first application displayed in a first window, and the second display content is a second application displayed in the second window; and
a size of the first window is same as a size of the first display region, and a size of the second window is same as a size of the second display region.

4. The display method of claim 1, wherein controlling the first display region of the device to display the first display content and the second display region to display the second display content comprises:
controlling the device to generate the first display region and the second display region, wherein the first display region and the second display region have a same shape and are symmetrically positioned; and
controlling the first display region to display the first display content and the second display region to display the second display content, wherein
a first content element of the first display content is same as a first content element of the second display content;
the second content has a first relative position with respect to the first content element of the first display content;
the target translation language content for the second content has a second relative position with respect to the first content element of the second display content; and
the first relative position matches the second relative position.

5. The display method of claim 4, wherein obtaining the first content comprises: obtaining a display structure and a non-text format content element of the first display content as the first content, wherein
the display structure comprises layout information for a text format content element and the non-text format content element; and
the non-text format content element forms the first content element.

6. The display method of claim 1, wherein obtaining the second content comprises:
at least determining, in the first display content, a view region that contains non-text format text information, and recognizing text information within the view region to obtain the second content; or
obtaining a view tree or an object model of the first display content and determining the second content based on a text resource in the view tree or the object model.

7. The display method of claim 5, further comprising:
determining a display structure and a non-text format content element of the second display content based on the first content;
constructing a view tree corresponding to the second display content, based on the display structure and the non-text format content element of the second display content, and the target translation language content; and
controlling to display the second display content based on the view tree corresponding to the second display content.

8. The display method of claim 7, further comprising:
replacing text information contained in the non-text format content element with the target translation language content using an inpainting method to update text information of a corresponding content element,
wherein, constructing the view tree corresponding to the second display content based on the display structure and the non-text format content element of the second display content, and the target translation language content, comprises:
constructing the view tree corresponding to the second display content based on the display structure and an updated non-text format content element of the second display content, and the target translation language content.

9. The display method of claim 1, further comprising:
monitoring changes in the first display content within the first display region to synchronously update the second display content displayed in the second display region, wherein a size of the first display region changes as a size of the second display region changes.

10. An electronic device, comprising:
a display screen, configured to display content; and
one or more processors, configured to:
obtain, in response to an activation of a target mode, a first display content currently displayed, wherein the first display content comprises a first content related to a display layout and a second content related to language information displayed, and the second content comprises content determined by non-text format information displayed;
obtain a target translation language content for the second content; and
control a first display region of the display screen to display the first display content and a second display region to display a second display content, wherein the second display content comprises the first content and the target translation language content for the second content.

11. The electronic device of claim 10, wherein the one or more processors are further configured to:
control, in response to an activation of a first target mode, the first display content to display in the first display region and the second display content to display in the second display region, wherein a display region of the display screen at least is able to be divided into the first display region and the second display region; or
control, in response to an activation of a second target mode, the first display content to be transmitted and displayed in a first display region of a first device through a first channel, and control the second display content to be transmitted and displayed in a second display region of a second device through a second channel, wherein the first channel and the second channel are different.

12. The electronic device of claim 11, wherein the one or more processors are further configured to generate a second window and display the second window in the second display region, wherein
the second window is configured to display the second display content;
the first display content is a first application displayed in a first window, and the second display content is a second application displayed in the second window; and
a size of the first window is same as a size of the first display region, and a size of the second window is same as a size of the second display region.

13. The electronic device of claim 10, wherein the one or more processors are further configured to:
control the electronic device to generate the first display region and the second display region, wherein the first display region and the second display region have a same shape and are symmetrically positioned; and
control the first display region to display the first display content and the second display region to display the second display content, wherein
a first content element of the first display content is same as a first content element of the second display content;
the second content has a first relative position with respect to the first content element of the first display content;
the target translation language content for the second content has a second relative position with respect to the first content element of the second display content; and
the first relative position matches the second relative position.

14. The electronic device of claim 13, wherein the one or more processors are further configured to obtain a display structure and a non-text format content element of the first display content as the first content, wherein
the display structure comprises layout information for a text format content element and the non-text format content element; and
the non-text format content element forms the first content element.

15. The electronic device of claim 10, wherein the one or more processors are further configured to:
at least determine, in the first display content, a view region that contains non-text format text information, and recognize text information within the view region to obtain the second content; or
obtain a view tree or an object model of the first display content and determining the second content based on a text resource in the view tree or the object model.

16. The electronic device of claim 14, wherein the one or more processors are further configured to:
determine a display structure and a non-text format content element of the second display content based on the first content;
construct a view tree corresponding to the second display content, based on the display structure and the non-text format content element of the second display content, and the target translation language content; and
control to display the second display content based on the view tree corresponding to the second display content.

17. The electronic device of claim 16, wherein the one or more processors are further configured to:
replace text information contained in the non-text format content element with the target translation language content using an inpainting method to update text information of a corresponding content element; and
construct the view tree corresponding to the second display content based on the display structure and an updated non-text format content element of the second display content, and the target translation language content.

18. The electronic device of claim 10, wherein the one or more processors are further configured to monitor changes in the first display content within the first display region to synchronously update the second display content displayed in the second display region, wherein a size of the first display region changes as a size of the second display region changes.

19. A non-transitory computer-readable storage medium containing instructions that, when being executed, cause at least one processor to perform operations comprising:
obtaining, in response to an activation of a target mode, a first display content currently displayed, wherein the first display content comprises a first content related to a display layout and second content related to language information displayed, and the second content comprises content determined by non-text format information displayed;
obtaining a target translation language content for the second content; and
controlling a first display region of the device to display the first display content and a second display region to display a second display content, wherein the second display content comprises the first content and the target translation language content for the second content.

20. The non-transitory computer-readable storage medium of claim 19, wherein the operations further comprise:
in response to an activation of a first target mode, controlling the first display content to be displayed in the first display region and the second display content to be displayed in the second display region, wherein a display region of a screen is able to be divided into at least the first display region and the second display region; or
in response to an activation of a second target mode, controlling the first display content to be transmitted through a first channel and displayed in a first display region of a first device, and controlling the second display content to be transmitted through a second channel and displayed in a second display region of a second device, wherein the first channel and the second channel are different.
